(19) United States
(12) Patent Application Publication
(10) Pub. No.: US 2026/0112834 A1
(43) Pub. Date: Apr. 23, 2026

(54) POWER CONNECTOR, POWER TERMINAL ASSEMBLY AND CONNECTOR ASSEMBLY

(71) Applicant: OUPIIN Electronic (Kunshan) Co., Ltd, Kunshan City (CN)

(72) Inventor: Hsin Chih CHEN, Kunshan City (CN)

(73) Assignee: OUPIIN Electronic (Kunshan) Co., Ltd, Kunshan City (CN)

(21) Appl. No.: 19/015,897

(22) Filed: Jan. 10, 2025

(30) Foreign Application Priority Data
Oct. 22, 2024 (CN) 202411475128.3
Oct. 22, 2024 (CN) 202422548877.6

(51) Int. Cl. H01R 13/24; H01R 13/514; H01R 27/02

(52) U.S. Cl. CPC H01R 13/2407; H01R 13/2464; H01R 13/514; H01R 27/02

(57) ABSTRACT

A power connector, a power terminal assembly and a connector assembly are disclosed in this application. The power terminal assembly includes a first power terminal, a second power terminal combined with the first power terminal, at least one clamping structure disposed on the first power terminal, and at least one insertion structure disposed on the second power terminal. The clamping structure includes two opposite clamping beams. The insertion structure includes a first straight beam and a second straight beam formed by folding. When mating, the first terminal and the second terminal can not separate. Therefore, power terminal assembly of the application has a stable and safe engaging structure to provide stable current conduction capability for the power connector and the connector assembly of the present application and improve service life.

### RELATED APPLICATIONS

This application claims the benefit of priority of Chinese Patent Application Nos. 202411475128.3 and 202422548877.6, both of which were filed on Oct. 22, 2024. The contents of the above applications are all incorporated by reference as if fully set forth herein in their entirety.

### FIELD AND BACKGROUND OF THE INVENTION

The present application relates to a field of connector technology, and more specifically to a power connector, a power terminal assembly and a connector assembly.

A PwrMAX power connector is very suitable for high-end data, telecommunications and industrial equipment and can provide power services for systems that require high density and high current.

Regarding an existing power connector, please refer to US Patent Publication No. U.S. Pat. No. 7,905,731B2, which discloses an electrical connector with stress distribution features. A contact of the electrical connector includes a first half and a second half. The first half and the second half both have alternating straight contact beams and angled contact beams. When the first half and the second half are combined, the straight contact beam of the first half and the straight contact beam of the second half are combined to a straight contact beam pair, and the angled contact beam of the first half and the angled contact beam of the second half are combined to an angled contact beam pair. When the electrical connector is engaged with another connector, the straight contact beam pair of the electrical connector can be inserted into an angled contact beam pair of the another connector, and a straight contact beam pair of the another connector can be inserted into the angled contact beam pair of the electrical connector.

However, when the electrical connector is engaged with the another connector, the first half and second half of the above-mentioned contact are easily separated. For example, when the straight contact beam pair of the another connector is inserted into the angled contact beam pair of the electrical connector, the angled contact beam pair of the electrical connector will be forced to open a certain distance. Therefore, a main body of the first half and a main body of the second half of the electrical connector are also easily forced to open with the angled contact beam pair. Although it is desired to fix the first half and the second half together through the engagement of a thru hole of the first half and a dimple of the second half, it is still impossible to completely avoid the risk of the first half and the second half being separated.

Moreover, for the straight contact beam pair, if one of the straight contact beam pair does not have good flatness, a gap will be formed between the straight contact beam pair. During insertion, if the straight contact beam pair is not aligned with the angled contact beam pair, there may be a problem where one of the straight contact beam pair enters between the angled contact beam pair, and the other of the straight contact beam pair does not enter between the angled contact beam pair. That is to say, the two straight contact beams will be forced to open a larger gap, resulting in the main body of the first half and the main body of the second half also being forced to open.

The above situations will cause irreversible damage to the electrical connector and the another connector.

Hence, it is necessary to provide a new power transmitting structure for provide safe and reliable power services for high-density and high current systems.

### SUMMARY OF THE INVENTION

One object of the present application is to provide a power connector employing a power terminal assembly that has a stable structure and a safe engaging structure for providing stable current conduction capability.

Another object of the present application is to provide a power terminal assembly, wherein a first power terminal has an independent clamping structure, and a second power terminal has an independent insertion structure, both of which have stable and safe engaging structures, and can provide stable current conduction capability.

Further object of the present application is to provide a connector assembly being capable of safely engaging and stably transmitting current.

Other objects and advantages of the present application may be further understood from technical features disclosed by the present application.

To achieve the above objects of the present application, the present application adopts the following technical solution.

A power connector comprises an insulation base and at least one power terminal assembly disposed in the insulation base. The power terminal assembly comprises a first power terminal and a second power terminal combined together. The first power terminal comprises a first body with a first mating side, and at least one clamping structure disposed on the first mating side. The clamping structure comprises two clamping beams arranged opposite each other. The second power terminal comprises a second body with a second mating side, and at least one insertion structure disposed on the second mating side. The insertion structure comprises a first straight beam and a second straight beam formed by folding. Wherein, the first body and the second body are in parallel touch each other and are fixed together in the insulation base; and the clamping structure and the insertion structure are arranged in one column.

In one embodiment, the clamping structure comprises a sheet body, two side wings located on both sides of the sheet body, and an opening located between the two side wings; the sheet body and the side wings are perpendicular to the first body; the two clamping beams are symmetrically disposed on the two side wings and are perpendicular to the side wings; wherein each clamping beam has a contact portion and a guide portion; the clamping structure forms a clamping port between the contact portions of the two clamping beams, and a guide port between the guide portions of the two clamping beams; and the guide port, the clamping port and the opening are communicated.

In one embodiment, the sheet body is perpendicularly connected to the first mating side through a bent section; each clamping beam is formed by bending the corresponding side wing; and the contact portion and the guide portion are located below the opening.

In one embodiment, the insertion structure comprises a folded section connecting the first straight beam and the second straight beam; the folded section is located at one end of the insertion structure away from the second mating side; the first straight beam and the second straight beam are folded; wherein one end of the first straight beam is connected to the second mating side, and the other end of the first straight beam is connected to the folded section; and one end of the second straight beam is connected to the folded section, and the other end of the second straight beam is a free end.

In one embodiment, the first mating side of the first power terminal is provided with at least one first connection structure; and the second mating side of the second power terminal is provided with at least one second connection structure; when the first power terminal and the second power terminal are combined together, the sheet body is connected to the second connection structure, and the free end of the second straight beam is connected to the first connection structure.

In one embodiment, the first power terminal comprises multiple of the clamping structures and multiple of the first connection structures arranged alternately; the first connection structure is a first vertical edge; and the second power terminal comprises multiple of the insertion structures and multiple of the second connection structures arranged alternately; the second connection structure is a second vertical edge.

In one embodiment, the second straight beam is provided with a power connection section at the free end of the second straight beam, and a thickness of the power connection section is smaller than a thickness of the second straight beam; and the first connection structure comprises at least one power connection sheet, and a thickness of the power connection sheet is smaller than a thickness of the first body; wherein, the power connection section faces the power connection sheet; when the power terminal assembly is engaged with a mating terminal assembly, the power connection section is connected to the power connection sheet.

To achieve the above objects of the present application, the present application also adopts the following technical solution.

A power terminal assembly comprises a first power terminal and a second power terminal combined together. The first power terminal comprises a first body with a first mating side, at least one clamping structure disposed on the first mating side, and at least one first connection structure disposed on the first mating side. Wherein the clamping structure comprises two clamping beams arranged opposite each other. The second power terminal comprising a second body with a second mating side, at least one insertion structure disposed on the second mating side, and at least one second connection structure disposed on the second mating side. Wherein the insertion structure comprises a first straight beam and a second straight beam formed by folding. Wherein, the first body and the second body are in parallel touch each other to be fixed together in the insulation base, the clamping structure is connected to the second connection structure, and the insertion structure is connected to the first connection structure.

To achieve the above objects of the present application, the present application also adopts the following technical solution.

A connector assembly comprises a power connector and a mating connector. The power connector comprises an insulation base and at least one power terminal assembly disposed in the insulation base. The power terminal assembly comprises a first power terminal, a second power terminal combined with the first power terminal, at least one clamping structure disposed on the first power terminal, and at least one insertion structure disposed on the second power terminal. The mating connector comprises a mating base and at least one mating terminal assembly disposed in the mating base. The mating terminal assembly comprises a third power terminal, a fourth power terminal combined with the third power terminal, at least one clamping structure disposed on the third power terminal, and at least one insertion structure disposed on the fourth power terminal. Wherein, when the power connector and the mating connector are engaged, the insulation base is engaged with the mating base, the insertion structure of the power terminal assembly is engaged with the clamping structure of the mating terminal assembly to form an electrical connection for transmitting power, and the insertion structure of the mating terminal assembly is engaged with the clamping structure of the power terminal assembly to form an electrical connection for transmitting power.

In comparison with the prior art, the power terminal assembly of the present application disposes the clamping structure and the insertion structure on the two different power terminals. When the two clamping beams are forced to open, it will not cause the two power terminals to separate, and the first straight beam and the second straight beam formed by folding will not separate. Hence, the power terminal assembly of the present application has a stable and safe engaging structure to provide stable current conduction capability for the power connector and the connector assembly of the present application and improve service life. In addition, the power terminal assembly of the present application disposes the first and second connection structures to connect the first and second power terminals, to form a more complete power transmission path and improve the power transmission efficiency.

### BRIEF DESCRIPTION OF THE SEVERAL VIEWS OF THE DRAWING(S)

FIG. 1 is a perspective schematic view of one embodiment of a power connector of the present application;

FIG. 2 is a perspective schematic view of the power connector from another angle;

FIG. 3 is an exploded view of the power connector;

FIG. 4 is a perspective schematic view of one embodiment of a power terminal assembly of the present application;

FIG. 5 is a perspective schematic view of the power terminal assembly of FIG. 4 from another angle;

FIG. 6a is an exploded view of the power terminal assembly of FIG. 4;

FIG. 6b is an exploded view of the power terminal assembly of FIG. 4 from another angle;

FIG. 7a is a top view of a first power terminal and a second power terminal shown in FIG. 6a;

FIG. 7b is a side view of the first power terminal and the second power terminal shown in FIG. 6a;

FIG. 7c is a front view of the first power terminal and the second power terminal shown in FIG. 6a;

FIG. 8a is an exploded view of another embodiment of the power terminal assembly of the present application;

FIG. 8b is a cross-sectional view of a first power terminal and a second power terminal shown in FIG. 8a;

FIG. 9 is a perspective schematic view of a mating connector of the present application;

FIG. 10 is a perspective schematic view of the mating connector from another angle;

FIG. 11 is an exploded view of the mating connector;

FIG. 12 is a perspective schematic view of one mating terminal assembly of the present application;

FIG. 13 is a perspective schematic view of the mating terminal assembly from another angle;

FIG. 14 is an exploded view of the mating terminal assembly;

FIG. 15 is a perspective schematic view of a connector assembly of the present application; and

FIG. 16 is a cross-sectional view of the connector assembly, mainly showing the mating state of the power terminal assembly and the mating terminal assembly.

### DESCRIPTION OF SPECIFIC EMBODIMENTS OF THE INVENTION

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “top”, “bottom” etc., are only used with reference to the orientation of the accompanying drawings. Therefore, the used directional terms are intended to illustrate, but not to limit, the present application.

A connector assembly of the present application includes a power connector and a mating connector, which can be engaged together. The power connector can be referred to as a female connector, and the mating connector can be referred to as a male connector. Of course, the power connector can also be referred to as a male connector, and the mating connector can be referred to as a female connector. Alternatively, without distinguishing between the male and female connectors, the power connector is referred to as a first power connector, while the mating connector is referred to as a second power connector.

The power connector of the present application can solve the problems of unstable structure and unstable current transmission of an existing power terminal assembly during mating. The power connector of the present application can provide stable current conduction capability.

The following embodiments illustrate the power connector of the present application using a right angle power connector as an example, with its mating direction parallel to a circuit board. The power connector of the present application can also be an upright power connector, with its mating direction perpendicular to the circuit board. The power connector can also be a power connector at other angles, with its mating direction tilted toward the circuit board.

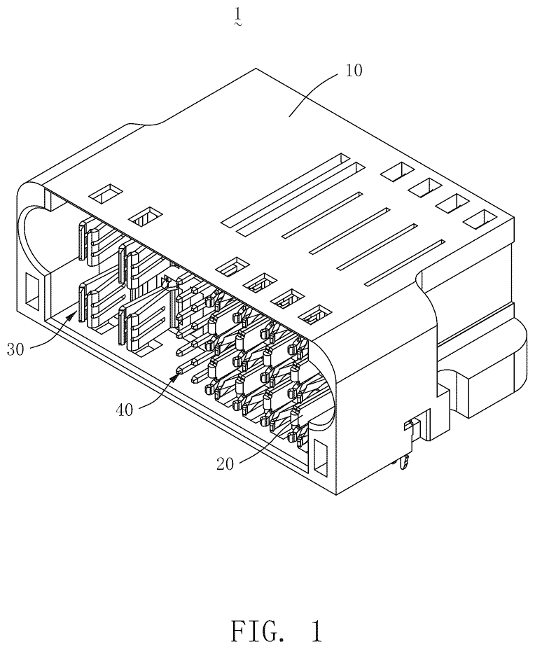

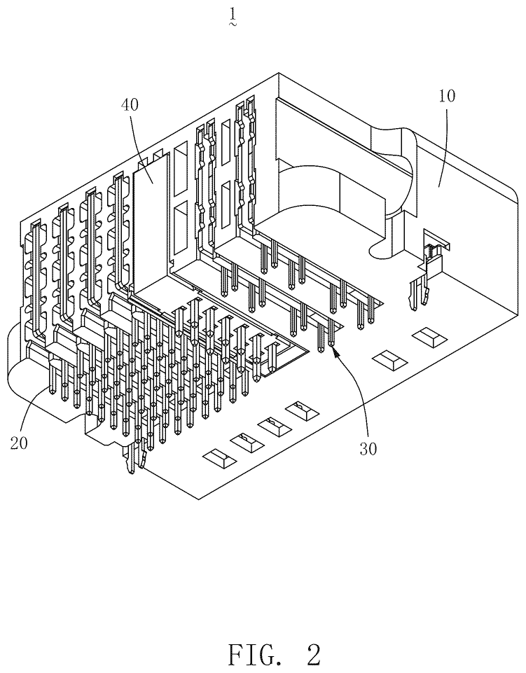

Please refer to FIGS. 1, 2 and 3, the power connector 1 of the present application includes an insulation base 10 and at least one power terminal assembly 20 disposed in the insulation base 10. The power terminal assembly 20 includes a first power terminal 21 and a second power terminal 22 combined together for transmitting power together. In this embodiment, the first power terminal 21 and the second power terminal 22 can be combined by being assembled together in a terminal channel 101 of the insulating base 10 and clamped by side walls of the terminal channel 101. In other embodiments, the first power terminal 21 and the second power terminal 22 can be combined together by disposing convex or concave locking structures (not shown) on the first power terminal 21 and the second power terminal 22, respectively.

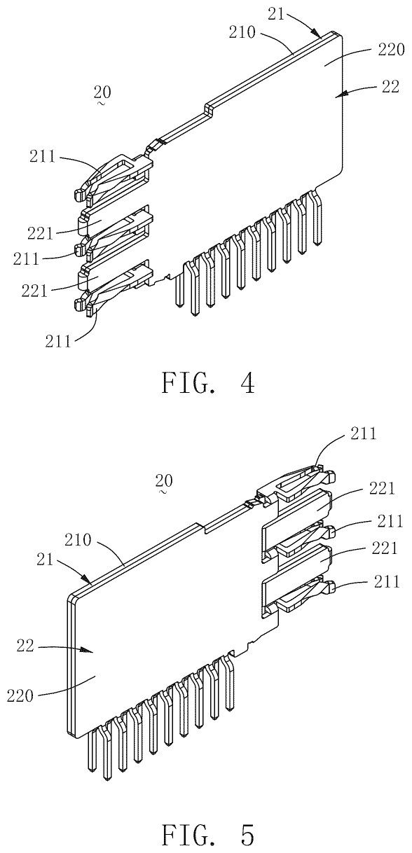

Please refer to the power terminal assembly 20 shown in FIGS. 4, 5, 6a and 6b, the first power terminal 21 includes: a first body 210 with a first mating side 2101, and at least one clamping structure 211 disposed on the first mating side 2101. The clamping structure 211 includes two clamping beams 212 arranged opposite each other. The second power terminal 22 includes a second body 220 with a second mating side 2201 and at least one insertion structure 221 disposed on the second mating side 2201. Wherein, the insertion structure 221 includes a first straight beam 222 and a second straight beam 223 formed by folding. Wherein, the first body 210 and the second body 220 are parallel and closely touch each other to be fixed together in the insulation base 10, and the clamping structure 211 and the insertion structure 221 are arranged in one column.

In this embodiment, the first power terminal 21 includes multiple of the clamping structures 211, and the second power terminal 22 includes multiple of the insertion structures 221. The clamping structures 211 and the insertion structures 221 are alternately arranged along a vertical direction. Of course, in other embodiments, the clamping structures 211 and the insertion structures 221 can also be alternately arranged along a horizontal direction.

In this embodiment, because the power connector 1 of the present application is a right angle type, the clamping structure 211 and the insertion structure 221 are arranged in one column along a vertical direction. But in other embodiments, when the power connector 1 of the present application is an upright type, the clamping structure 211 and the insertion structure 221 are arranged in a row along a horizontal direction.

The present application provides the clamping structure 211 on the first power terminal 21 and the insertion structure 221 on the second power terminal 22, so that they do not affect each other or cause separation between the first power terminal 21 and the second power terminal 22 during engaging. Therefore, the power terminal assembly 20 of the present application has a stable structure and a safe engaging function, which can provide stable current conduction capability for the power connector 1 of the present application and improve its service life.

The structure and advantages of the power terminal assembly 20 and the power connector 1 of the present application will be described in more detail below.

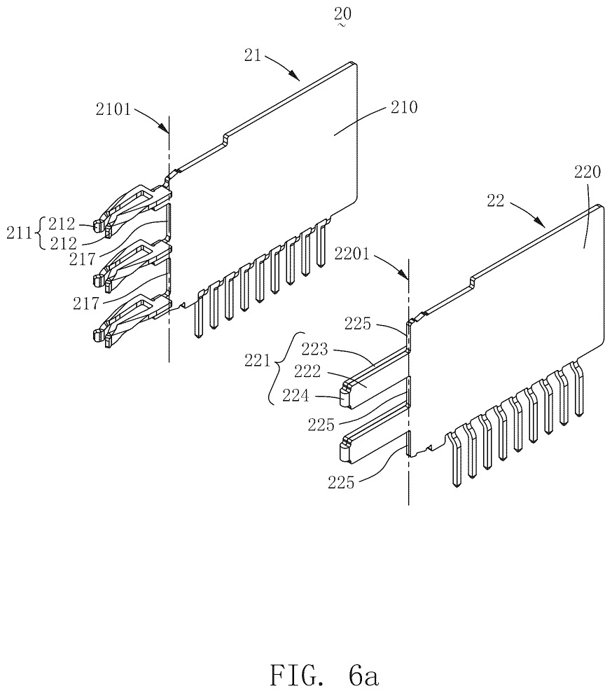

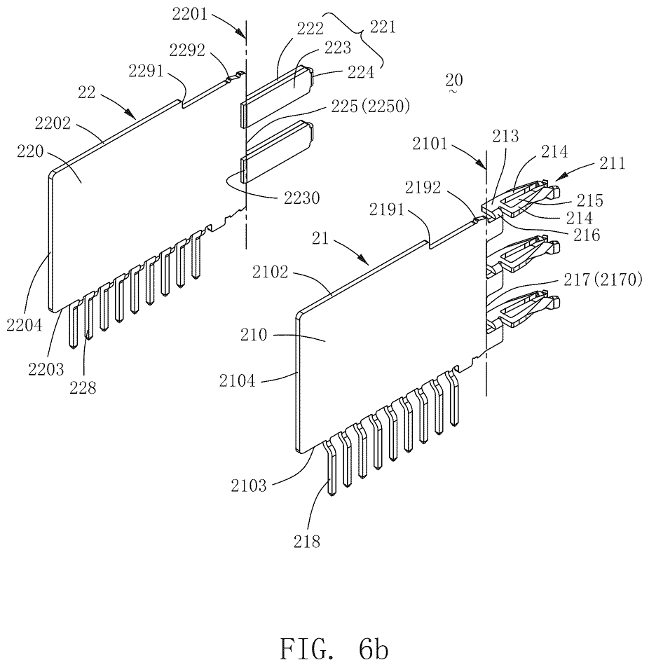

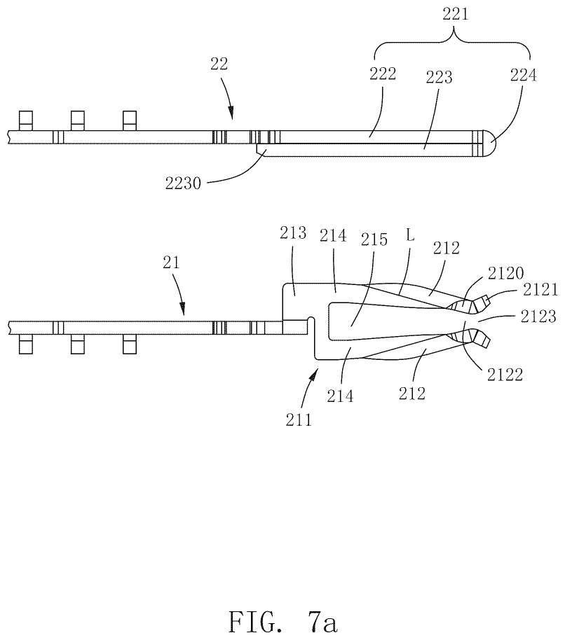

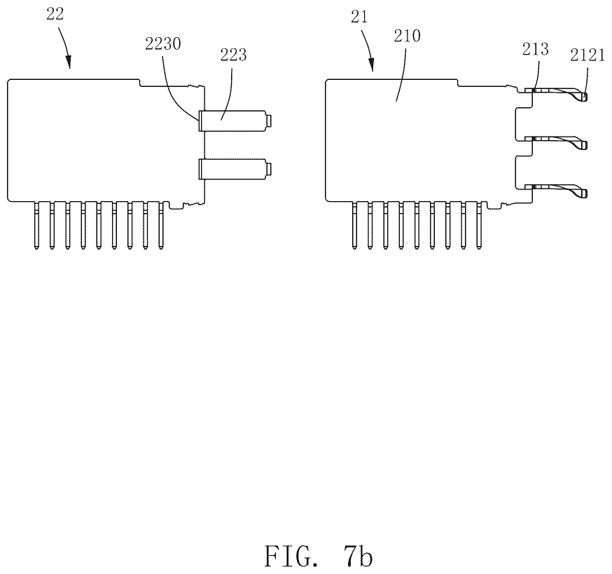

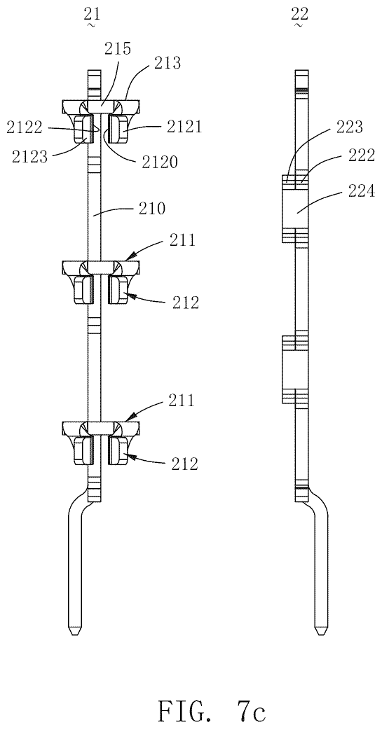

Please refer to FIGS. 6b and 7a, the clamping structure 211 includes a sheet body 213, two side wings 214 located on both sides of the sheet body 213, and an opening 215 located between the two side wings 214. The sheet body 213 and the side wings 214 are perpendicular to the first body 210, and the sheet body 213 is perpendicularly connected to the first mating side 2101 of the first body 210. Specifically, the sheet body 213 is perpendicularly connected to the first mating side 2101 of the first body 210 through a bent section 216. The two clamping beams 212 are symmetrically disposed on the two side wings 214 and are approximately perpendicular to the side wings 214. Specifically, each clamping beam 212 is formed by bending the corresponding side wing 214. Each clamping beam 212 has a contact portion 2120 and a guide portion 2121. From a top view shown in FIG. 7a, the contact portions 2120 of the two clamping beams 212 face each other, and the guide portion 2121 is located at a free end of the clamping beam 212 and extends away from the opening 215. From FIG. 7c, it can be seen that the contact portion 2120 and the guide portion 2121 are located below the opening 215.

In this embodiment, as shown in FIGS. 7a, 7b and 7c, the first body 210 is a vertical plate. The sheet body 213 is a horizontal piece that is perpendicular to the first body 210. The clamping beam 212 is formed by bending the side wing 214 vertically downward along an oblique line L (seen in FIG. 7a), and is approximately perpendicular to the sheet body 213. The clamping beam 212 is also horizontally bent outward in a direction away from the opening 215 to form the contact portion 2120 and the guide portion 2121. It can be seen that the clamping structure 211 is formed through multiple bending. For example, the sheet body 213 is formed by one perpendicular bending, and the clamping beam 212 is formed by two perpendicular bending. Of course, in the stamping and bending process, these bending can be completed simultaneously or sequentially.

In this embodiment, as shown in FIG. 7a, a width of the opening 215 is set to gradually decrease along a direction away from the first mating side 2101. The clamping structure 211 forms a clamping port 2122 between the contact portions 2120 of the two clamping beams 212 for providing elastic clamping and electrical contact functions. The clamping structure 211 further forms a guide port 2123 between the guide portions 2121 of the two clamping beams 212 for providing guidance. The guide port 2123, the clamping port 2122, and the opening 215 are communicated with each other. A width of the guide port 2123 is greater than a width of the clamping port 2122. The width of the clamping port 2122 is smaller than the width of the opening 215, especially smaller than the minimum width of the opening 215. When engaging, a mating terminal assembly 60 of the mating connector 2 enters into the clamping port 2122 from the guide port 2123, the contact portions 2120 of the two clamping beams 212 are forced to open, and finally the mating terminal assembly 60 is accommodated in the clamping port 2122 and the opening 215.

Please refer to FIGS. 6a, 6b, 7a, 7b and 7c, the insertion structure 221 further includes a folded section 224 connecting the first straight beam 222 and the second straight beam 223. The folded section 224 is located at one end of the insertion structure 221 away from the second mating side 2201, and the first straight beam 222 and the second straight beam 223 are folded. The insertion structure 221 of the present application is provided with the folded section 224, for not only achieving a folded shape of the first straight beam 222 and the second straight beam 223, but also guiding the first straight beam 222 and the second straight beam 223 to be smoothly inserted into the mating terminal assembly 60 during engaging, thereby achieving a safe mating effect.

Specifically, the insertion structure 221 is made by a folding process to form the first straight beam 222, the second straight beam 223, and the folded section 224. The folded section 224 is a similar cylindrical body with an arc cross-section. The first straight beam 222 and the second straight beam 223 are approximately parallel. It should be noted that the so-called folding process refers to a 180 degree bending process or a bending process close to 180 degrees. In fact, due to the influence of the bending process or terminal material, even if the 180 degree bending process is performed, it may be difficult for the first straight beam 222 and the second straight beam 223 to be completely parallel, but they are roughly folded. The cross-section of the folded section 224 described in the present application may be nearly semi-circular. In fact, as long as the folded section 224 can make the first straight beam 222 and the second straight beam 223 roughly be folded together, the insertion structure 221 has the function of safe engaging.

In this embodiment, one end of the first straight beam 222 is connected to the second mating side 2201, and the other end thereof is connected to the folded section 224. One end of the second straight beam 223 is connected to the folded section 224, and the other end thereof is a free end 2230.

Referring to FIG. 7a, a length of the second straight beam 223 is greater than a length of the first straight beam 222. The free end 2230 of the second straight beam 223 will extend backward, exceed the first straight beam 222, and attach to one side of the second body 220 facing the first power terminal 21.

Please refer to FIGS. 6a and 6b, the first mating side 2101 of the first power terminal 21 is provided with at least one first connection structure 217, and the second mating side 2201 of the second power terminal 22 is provided with at least one second connection structure 225. When the first power terminal 21 and the second power terminal 22 are combined together, the first body 210 and the second body 220 are in parallel touch each other, the sheet body 213 is connected to the second connection structure 225, and the free end 2230 of the second straight beam 223 is connected to the first connection structure 217. This can increase the rigidity of the clamping structure 211 and the insertion structure 221 in the mating direction, improve their mating strength, prevent displacement during mating, and further enhance the mating safety of the power terminal assembly 20. In addition, by connecting the sheet body 213 to the second connection structure 225 and connecting the second straight beam 223 to the first connection structure 217, the power terminal assembly 20 can further improve the power transmission efficiency of the first power terminal 21 and the second power terminal 22.

In this embodiment, the first power terminal 21 includes multiple of the clamping structures 211 and multiple of the first connection structures 217 arranged alternately (e.g., three clamping structures 211 and two first connection structures 217). Correspondingly, the second power terminal 22 includes multiple of the insertion structures 221 and multiple of the second connection structures 225 arranged alternately (e.g., two insertion structures 221 and three second connection structures 225). When the first power terminal 21 and the second power terminal 22 are combined together, the first connection structures 217 are connected to the corresponding second connection structures 225, and the insertion structures 221 are connected to the corresponding first connection structures 217. The clamping structures 211 and the insertion structures 221 are alternately arranged in one column to transmit power together.

In this embodiment, the first connection structure 217 is a vertical edge of the first body 210, which is referred to as a first vertical edge 2170 (seen in FIG. 6b). The second connection structure 225 is a vertical edge of the second body 220, which is referred to as a second vertical edge 2250 (seen in FIG. 6b). Correspondingly, the free end 2230 of the second straight beam 223 has a vertical free edge to match the first vertical edge 2170. The sheet body 213 has a horizontal contact edge to match the second vertical edge 2250. In other embodiments, the first connection structure 217 and the second connection structure 225 can also be arc edges or other shaped edges, and the free edge of the free end 2230 of the second straight beam 223 and the horizontal contact edge of the sheet body 213 can be correspondingly changed, so as to match each other during connection.

In other embodiments, the length of the second straight beam 223 may be equal to the length of the first straight beam 222, but it is necessary to ensure that the free end 2230 of the second straight beam 223 is connected to the first connection structure 217 in order to improve the mating strength of the insertion structure 221. It should also be noted that, for the sake of mating safety, the length of the second straight beam 223 should not be less than (but can be slightly less than) the length of the first straight beam 222, to ensure that the second straight beam 223 has a sufficiently long electrical contact region or a sufficiently large contact area when mating with the mating terminal assembly 60.

Please refer to FIG. 6b, in this embodiment, in addition to the first mating side 2101, the first body 210 further has a first retaining side 2102, a first mounting side 2103, and a first tail side 2104. The first mating side 2101 is arranged parallel to the first tail side 2104, the first retaining side 2102 is arranged parallel to the first mounting side 2103, and the first retaining side 2102 and the first mounting side 2103 are perpendicular to the first mating side 2101. More specifically, a front edge of the first body 210 is served as the first mating side 2101, and the first connection structure 217 can be directly served by the front edge of the first body 210. Moreover, in this embodiment, the front edge of the first body 210 is a rectangular tooth shaped structure (as shown in FIG. 6b), and the first connection structure 217 is an recess of the front edge.

The first power terminal 21 further includes multiple of pins 218 arranged in a row. In the embodiment, the pins 218 are disposed on the first mounting side 2103 and extend downward for being mounted to a circuit board (not shown). The first power terminal 21 further includes a retaining structure for retaining the first power terminal 21 to the insulation base 10. The retaining structure may include a shoulder 2191 provided on the first retaining side 2102, and multiple of protrusions 2192 provided on the first retaining side 2102 and the first mounting side 2103.

Similarly, in this embodiment, in addition to the second mating side 2201, the second body 220 further has a second retaining side 2202, a second mounting side 2203, and a second tail side 2204. The second mating side 2201 is arranged parallel to the second tail side 2204, the second retaining side 2202 is arranged parallel to the second mounting side 2203, and the second retaining side 2202 and the second mounting side 2203 are perpendicular to the second mating side 2201. More specifically, a front edge of the second body 220 is served as the second mating side 2201, and the second connection structure 225 can be directly served by the front edge of the second body 220. Moreover, in this embodiment, the front edge of the second body 220 is vertical (as shown in FIG. 6b).

The second power terminal 22 further includes multiple of pins 228 arranged in a row. In the embodiment, the pins 228 are disposed on the second mounting side 2203 and extend downward for being mounted to a circuit board (not shown). The second power terminal 22 further includes a retaining structure for retaining the second power terminal 22 to the insulation base 10. The retaining structure may include a shoulder 2291 provided on the second retaining side 2202, and multiple of protrusions 2292 provided on the second retaining side 2202 and the second mounting side 2203.

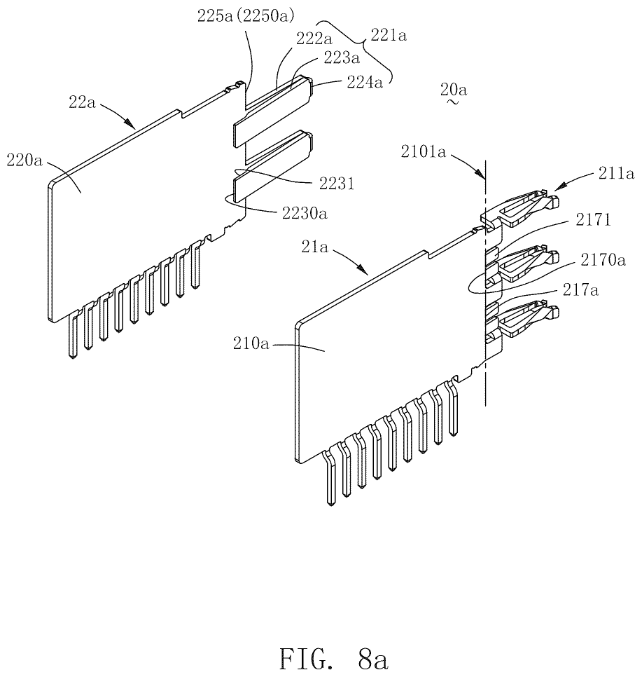

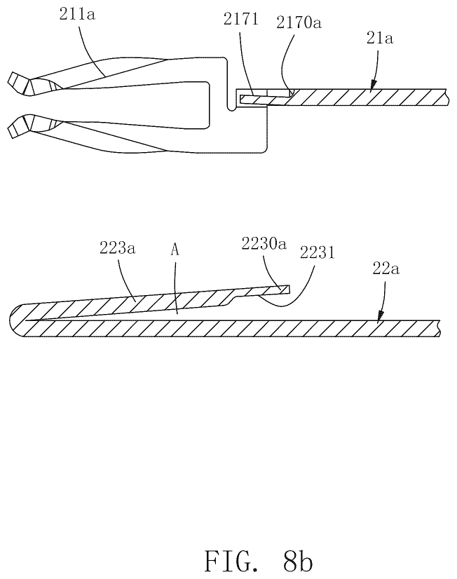

The following will introduce another embodiment of a power terminal assembly 20a of the present invention as shown in FIGS. 8a and 8b. The power terminal assembly 20a of FIGS. 8a and 8b is alike to the power terminal assembly 20 of FIGS. 6a and 6b. Like elements or structures of the power terminal assembly 20a with the power terminal assembly 20 share the same reference numerals with the addition of the suffix “a”.

Please refer to a second power terminal 22a shown in FIG. 8a, an insertion structure 221a forms a first straight beam 222a, a second straight beam 223a, and a folded section 224a through a folding process. The first straight beam 222a and the second straight beam 223a are not completely parallel, and there is an angle A (seen in FIG. 8b) between them. In addition, the second straight beam 223a is provided with a power connection section 2231, which is located at a free end or in a region adjacent to the free end of the second straight beam 223a. A thickness of the power connection section 2231 is smaller than a thickness of other regions of the second straight beam 223a. More specifically, at one side of the free end of the second straight beam 223a or the region adjacent to the free end, which faces a second body 220a of the second power terminal 22a, it is thinned to form the power connection section 2231. Therefore, the power connection section 2231 can be referred to as a thinning section.

Moreover, in the embodiment of FIG. 8a, a second connection structure 225a is a vertical edge of the second body 220a, which is referred to as a second vertical edge 2250a.

Please refer to a first power terminal 21a shown in FIG. 8a. A first connection structure 217a includes at least one power connection sheet 2171. The power connection sheet 2171 protrudes forward from a vertical edge (which is referred to as a first vertical edge 2170a) of a first body 210a in a direction approximately perpendicular to a first mating side 2101a. In fact, the power connection sheet 2171 is slightly tilted toward a first body 210a and tilted toward the second power terminal 22a, in order to form a reliable connection with the power connection section 2231. A thickness of the power connection sheet 2171 is smaller than a thickness of the first body 210a. Therefore, the power connection sheet 2171 can be referred to as a thinning sheet. In this embodiment, the power connection sheet 2171 and the first body 210a are integrally manufactured.

Please refer to FIGS. 8a and 8b, when the first power terminal 21a and the second power terminal 22a are combined together, the power connection section 2231 faces the power connection sheet 2171, and a clamping structure 211a is connected to the second connection structure 225a. When the power terminal assembly 20a is engaged with a mating terminal assembly (not shown), the power connection section 2231 moves towards the power connection sheet 2171 and is connected to the power connection sheet 2171. The free end 2230a of the second straight beam 223a may be in contact with the first vertical edge 2170a, or not be in contact with the first vertical edge 2170a.

In the embodiment shown in FIGS. 8a and 8b, the power terminal assembly 20a of the present application can improve the power transmission efficiency by disposing the power connection sheet 2171 and the power connection section 2231, which can form a more complete power transmission path between the first power terminal 21a and the second power terminal 22a. In addition, due to the thinning design of the power connection section 2231 and the power connection sheet 2171, it can not only improve the stability of the combination between the power connection section 2231 and the power connection sheet 2171, but also can not increase the total thickness of the first power terminal 21a and the second power terminal 22a after combined.

Please refer to FIGS. 1, 2 and 3, in the embodiment, the power connector 1 of the present application includes multiple of the power terminal assemblies 20.

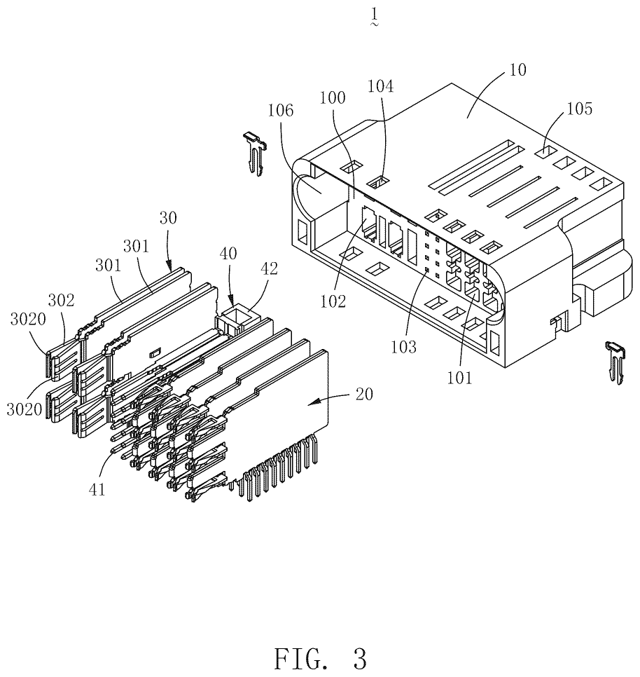

The power connector 1 of the present application further includes multiple of other power terminal assemblies. If the above power terminal assembly 20 is referred to as a first type power terminal assembly 20, then the other power terminal assemblies can be referred to as a second type power terminal assembly 30, which has a structure different from the first type power terminal assembly 20. In detail, as shown in FIG. 3, each second type power terminal assembly 30 includes two power terminals 301 symmetrically arranged, and multiple pairs of elastic beams 302 are formed at front ends of the two power terminals 301. Each the pair of elastic beams 302 has a pair of external contact portions 3020 facing away from each other.

The power connector 1 of the present application further includes a signal terminal module 40. The signal terminal module 40 includes multiple of signal terminals 41 arranged in at least one column and a fixing seat 42 for fixing the signal terminals 41.

In this embodiment, as shown in FIG. 3, the first type power terminal assembly 20 and the second type power terminal assembly 30 are respectively arranged on both sides of the signal terminal module 40.

Please refer to FIG. 3, the insulation base 10 includes a mating interface 100 and three groups of terminal channels 101, 102 and 103. The mating interface 100 is located at a front end of the insulation base 10, and the three groups of terminal channels 101, 102 and 103 pass through the mating interface 100, a rear surface of the insulation base 10, and a bottom surface of the insulation base 10. The three groups of terminal channels 101, 102 and 103 are used to respectively accommodate and fix the first type power terminal assembly 20, the second type power terminal assembly 30 and the signal terminal 41. Wherein, the clamping structure 211 and the insertion structure 221 of the first type power terminal assembly 20, the elastic beams 302 of the second type power terminal assembly 30, and a front mating section of the signal terminal 41 all enter into the mating interface 100. The pins 218 and 228 of the first type power terminal assembly 20, pins of the second type power terminal assembly 30, and pins of the signal terminal 41 all protrude from the bottom surface of the insulating base 10. The first type power terminal assembly 20 and the second type power terminal assembly 30 are both locked in the insulating base 10 through their respective retaining structures. And the signal terminal 41 is fixed in the insulating base 10 by the fixing seat 42.

In addition, as shown in FIG. 3, the insulation base 10 of the present application is also provided with multiple of first heat dissipation holes 104 and multiple of second heat dissipation holes 105. The first heat dissipation holes 104 are distributed on the top and bottom surfaces of the insulation base 10 and correspond to a position of the mating interface 100 for being communicated with the mating interface 100. The second heat dissipation holes 105 are distributed on the top surface of the insulation base 10, and are located near the rear surface. The insulation base 10 of the present application is also provided with two symmetrical guide passages 106 distributed on both sides of the mating interface 100 for guiding the mating connector 2 to be accurately inserted into the mating interface 100.

The structure and advantages of the mating connector 2 and the connector assembly 3 of the present application will be described in detail below.

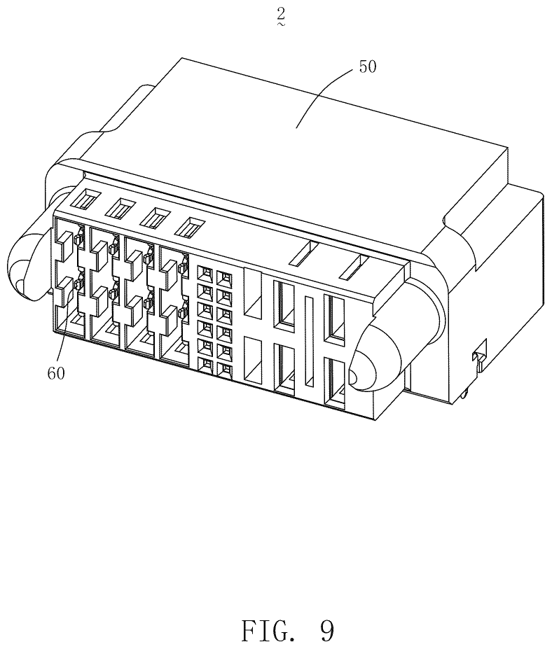

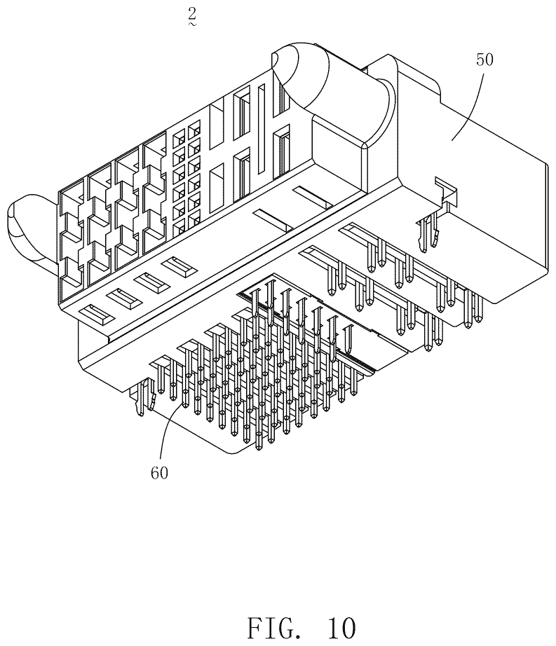

Please refer to FIGS. 9, 10 and 11, the mating connector 2 of the present application includes a mating base 50 and at least one mating terminal assembly 60 disposed in the mating base 50.

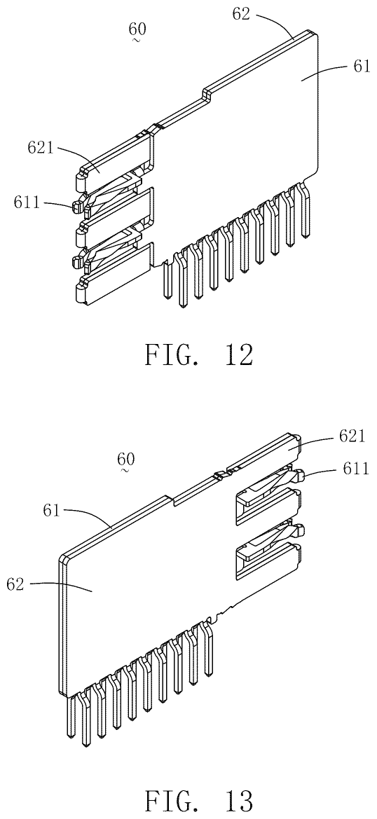

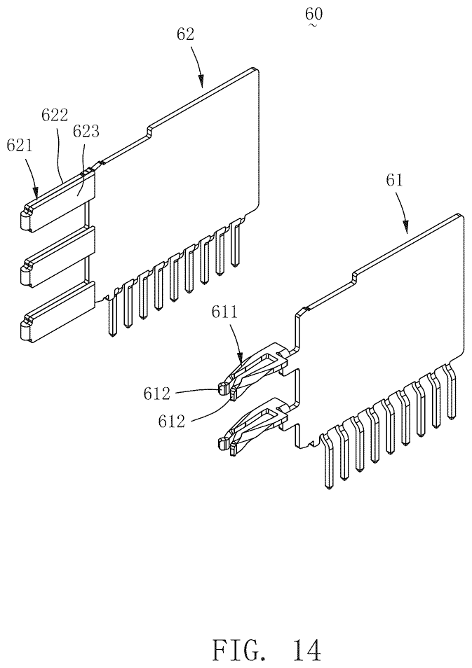

Please refer to FIGS. 12, 13 and 14, the mating terminal assembly 60 includes a third power terminal 61 and a fourth power terminal 62 combined to transmit power together. The mating terminal assembly 60 has a similar structure to the power terminal assembly 20. For example, the mating terminal assembly 60 includes at least one clamping structure 611 provided on the third power terminal 61 and at least one insertion structure 621 provided on the fourth power terminal 62. As shown in FIG. 14, the clamping structure 611 includes two opposing clamping beams 612, and the insertion structure 621 includes a third straight beam 622 and a fourth straight beam 623 formed by folding.

A main difference between the mating terminal assembly 60 and the power terminal assembly 20 is that: the clamping structures 211, 611 and the insertion structure 221, 621 are different in positions and quantities, in order to be matched during engaging. For example, in this embodiment, the power terminal assembly 20 is provided with three clamping structures 211 and two insertion structures 221, and correspondingly, the mating terminal assembly 60 is provided with three insertion structures 621 and two clamp structures 611.

Of course, in other embodiments, the mating terminal assembly 60 may also have a similar structure to the power terminal assembly 20a. Here will be not further elaborated.

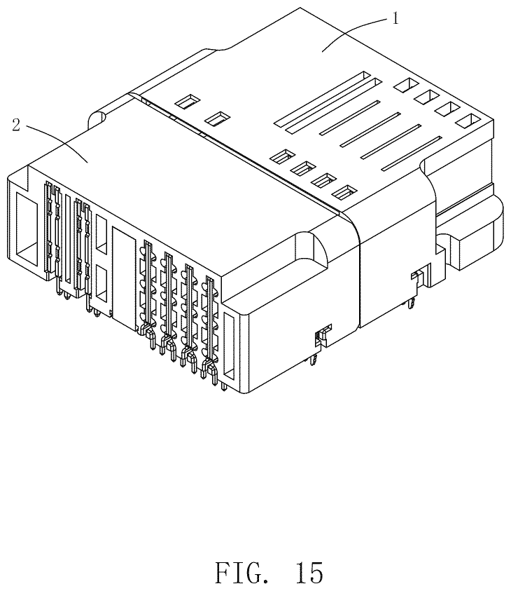

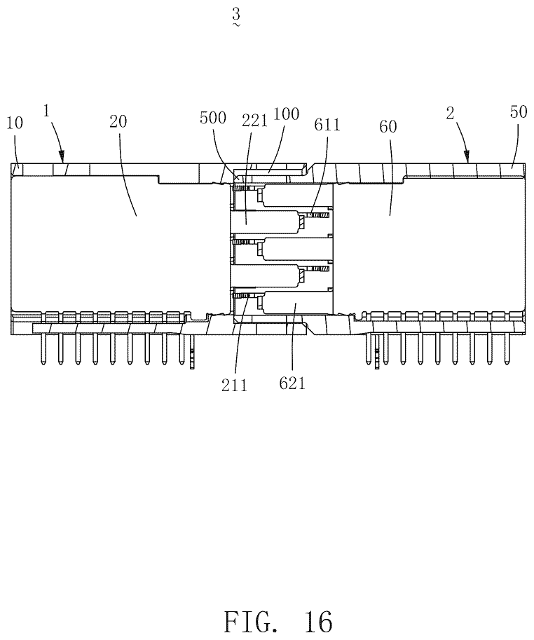

Please refer to the connector assembly 3 shown in FIGS. 15 and 16. When the power connector 1 is engaged with the mating connector 2, the insertion structure 221 of the power terminal assembly 20 is matched with the clamping structure 611 of the mating terminal assembly 60, and the insertion structure 621 of the mating terminal assembly 60 is matched with the clamping structure 211 of the power terminal assembly 20, thereby forming an electrical connection for commonly transmitting power. Please refer to FIGS. 6b and 14, the first straight beam 222 and the second straight beam 223 of the power terminal assembly 20 are inserted between the two clamping beams 612 of the mating terminal assembly 60, and the third straight beam 622 and the fourth straight beam 623 of the mating terminal assembly 60 are inserted between the two clamping beams 212 of the power terminal assembly 20.

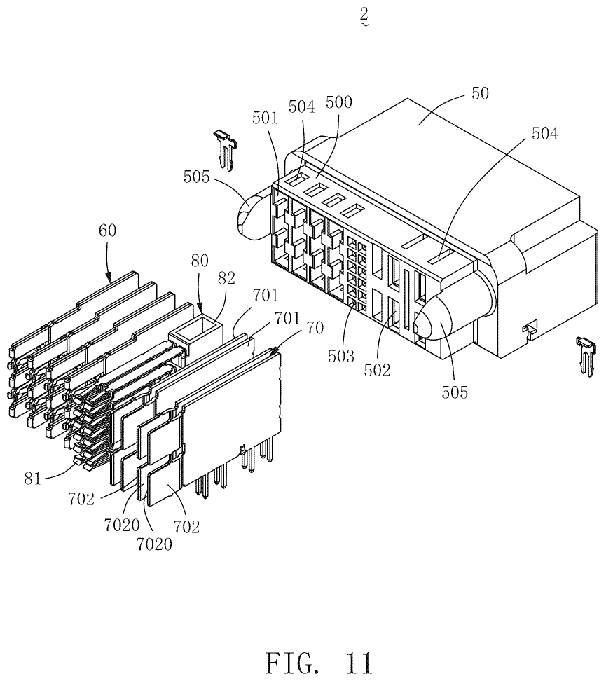

Please refer to FIG. 11 again. In this embodiment, the mating connector 2 of the present application includes multiple of the mating terminal assemblies 60.

The mating connector 2 of the present application further includes multiple of other mating terminal assemblies. If the above mating terminal assembly 60 is referred to as a third type power terminal assembly 60, then the other mating terminal assemblies can be referred to as a fourth type power terminal assembly 70, which has a structure different from the third type power terminal assembly 60. In detail, as shown in FIG. 11, each fourth type power terminal assembly 70 includes two mating terminals 701 symmetrically arranged. The two mating terminals 701 form multiple pairs of blade beams 702 at front ends of the two mating terminals 701. Each the pair of blade beams 702 has a pair of internal contact portions 7020 facing each other.

The mating connector 2 of the present application further includes a mating signal terminal module 80 arranged between the third type power terminal assembly 60 and the fourth type power terminal assembly 70. The mating signal terminal module 80 includes multiple mating signal terminals 81 arranged in at least one column and a mating fixing seat 82 for fixing the mating signal terminals 81.

In addition, as shown in FIG. 11, the mating base 50 is also provided with an insertion section 500 located at a front end of the mating base 50 and three groups of mating terminal channels 501, 502, 503. The mating terminal channels 501, 502, 503 pass through a front surface of the insertion section 500, a rear surface of the mating base 50, and a bottom surface of the mating base 50 for accommodating and fixing the third type power terminal assembly 60, the fourth type power terminal assembly 70 and the mating signal terminal 81, respectively.

When the power connector 1 and the mating connector 2 are engaged together, as shown in FIG. 16, the insertion section 500 of the mating base 50 enters into the mating interface 100 of the insulating base 10, and the insertion structure 221 and the clamping structure 211 of the first type power terminal assembly 20 are respectively engaged with the clamping structure 611 and the insertion structure 621 of the third type power terminal assembly 60 to form an electrical connection for transmitting power. In addition, the elastic beams 302 (especially the external contact portions 3020 of the elastic beams) of the second type power terminal assembly 30 are connected to the blade beams 702 (especially the internal contact portions 7020 of the blade beams 702) of the fourth type power terminal assembly 70 to form an electrical connection for transmitting power. The signal terminal 41 and the mating signal terminal 81 form an electrical connection for transmitting signals.

Please refer to FIG. 11 again, the mating base 50 of the present application is further provided with multiple third heat dissipation holes 504, which are distributed on the top and bottom surfaces of the insertion section 500 and pass through the mating terminal channels 501, 502. The mating base 50 is also provided with two symmetrical guide posts 505, which are distributed on both sides of the insertion section 500 and can guide the mating connector 2 to accurately insert into the mating interface 100.

As described above, the power terminal assembly 20 of the present application disposes the clamping structure 211 and the insertion structure 221 on the two different power terminals (such as the first power terminal 21 and the second power terminal 22). When the two clamping beams 212 are forced to open, it will not cause the first power terminal 21 and the second power terminal 22 to separate, and the first straight beam 222 and the second straight beam 223 formed by folding will not separate. Hence, the power connector 1 and the connector assembly 3 of the present application has a stable and safe engaging structure, can provide stable current conduction capability and can improve service life.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. A power connector, comprising an insulation base and at least one power terminal assembly disposed in the insulation base; the power terminal assembly comprising a first power terminal and a second power terminal combined together;
the first power terminal comprising a first body with a first mating side, and at least one clamping structure disposed on the first mating side; the clamping structure comprising two clamping beams arranged opposite each other; and
the second power terminal comprising a second body with a second mating side, and at least one insertion structure disposed on the second mating side; the insertion structure comprising a first straight beam and a second straight beam formed by folding;
wherein, the first body and the second body are in parallel touch each other and are fixed together in the insulation base; and the clamping structure and the insertion structure are arranged in one column.

2. The power connector according to claim 1, wherein the clamping structure comprises a sheet body, two side wings located on both sides of the sheet body, and an opening located between the two side wings;
the sheet body and the side wings are perpendicular to the first body;
the two clamping beams are symmetrically disposed on the two side wings and are perpendicular to the side wings; wherein each clamping beam has a contact portion and a guide portion;
the clamping structure forms a clamping port between the contact portions of the two clamping beams, and a guide port between the guide portions of the two clamping beams; and
the guide port, the clamping port and the opening are communicated.

3. The power connector according to claim 2, wherein a width of the opening is set to gradually decrease along a direction away from the first mating side;
a width of the guide port is greater than a width of the clamping port; and
the width of the clamping port is smaller than the width of the opening.

4. The power connector according to claim 2, wherein the sheet body is perpendicularly connected to the first mating side through a bent section;
each clamping beam is formed by bending the corresponding side wing; and
the contact portion and the guide portion are located below the opening.

5. The power connector according to claim 2, wherein the insertion structure comprises a folded section connecting the first straight beam and the second straight beam;
the folded section is located at one end of the insertion structure away from the second mating side;
the first straight beam and the second straight beam are folded; wherein one end of the first straight beam is connected to the second mating side, and the other end of the first straight beam is connected to the folded section; and one end of the second straight beam is connected to the folded section, and the other end of the second straight beam is a free end.

6. The power connector according to claim 5, wherein a length of the second straight beam is greater than a length of the first straight beam.

7. The power connector according to claim 5, wherein the first mating side of the first power terminal is provided with at least one first connection structure; and
the second mating side of the second power terminal is provided with at least one second connection structure;
when the first power terminal and the second power terminal are combined together, the sheet body is connected to the second connection structure, and the free end of the second straight beam is connected to the first connection structure.

8. The power connector according to claim 7, wherein the first power terminal comprises multiple of the clamping structures and multiple of the first connection structures arranged alternately; the first connection structure is a first vertical edge; and
the second power terminal comprises multiple of the insertion structures and multiple of the second connection structures arranged alternately; the second connection structure is a second vertical edge.

9. The power connector according to claim 7, wherein the second straight beam is provided with a power connection section at the free end of the second straight beam, and a thickness of the power connection section is smaller than a thickness of the second straight beam; and
the first connection structure comprises at least one power connection sheet, and a thickness of the power connection sheet is smaller than a thickness of the first body;
wherein, the power connection section faces the power connection sheet; when the power terminal assembly is engaged with a mating terminal assembly, the power connection section is connected to the power connection sheet.

10. A power terminal assembly, comprising a first power terminal and a second power terminal combined together;
the first power terminal comprising a first body with a first mating side, at least one clamping structure disposed on the first mating side, and at least one first connection structure disposed on the first mating side; wherein the clamping structure comprises two clamping beams arranged opposite each other;
the second power terminal comprising a second body with a second mating side, at least one insertion structure disposed on the second mating side, and at least one second connection structure disposed on the second mating side; wherein the insertion structure comprises a first straight beam and a second straight beam formed by folding;
wherein, the first body and the second body are in parallel touch each other to be fixed together in the insulation base, the clamping structure is connected to the second connection structure, and the insertion structure is connected to the first connection structure.

11. A connector assembly, comprising a power connector and a mating connector;
the power connector comprising an insulation base and at least one power terminal assembly disposed in the insulation base; the power terminal assembly comprising a first power terminal, a second power terminal combined with the first power terminal, at least one clamping structure disposed on the first power terminal, and at least one insertion structure disposed on the second power terminal; and
the mating connector comprising a mating base and at least one mating terminal assembly disposed in the mating base; the mating terminal assembly comprising a third power terminal, a fourth power terminal combined with the third power terminal, at least one clamping structure disposed on the third power terminal, and at least one insertion structure disposed on the fourth power terminal;
wherein, when the power connector and the mating connector are engaged, the insulation base is engaged with the mating base, the insertion structure of the power terminal assembly is engaged with the clamping structure of the mating terminal assembly to form an electrical connection for transmitting power, and the insertion structure of the mating terminal assembly is engaged with the clamping structure of the power terminal assembly to form an electrical connection for transmitting power.

12. The connector assembly according to claim 11, wherein the power connector comprises multiple of the power terminal assemblies, and the power terminal assembly is referred to as a first type power terminal assembly;
the power connector comprises multiple of second type power terminal assemblies; wherein, the second type power terminal assembly has two symmetrically arranged power terminals, which form multiple pairs of elastic beams at front ends of the two power terminals; each the pair of elastic beams has a pair of external contact portions facing away from each other; and
the power connector comprises a signal terminal module, which comprises multiple signal terminals arranged in at least one column and a fixing seat for fixing the signal terminals.

13. The connector assembly according to claim 12, wherein the mating terminal assembly comprises multiple of the mating terminal assemblies, and the mating terminal assembly is referred to as a third type power terminal assembly;
the mating terminal assembly comprises multiple of fourth type power terminal assemblies; wherein, the fourth type power terminal assembly comprises two mating terminals, which are symmetrically arranged and form multiple pairs of blade beams at front ends of the two mating terminals; each the pair of blade beams has a pair of internal contact portions facing each other; and
the mating terminal assembly comprises a mating signal terminal module, which comprises multiple mating signal terminals arranged in at least one column and a mating fixing seat for fixing the mating signal terminals.
